(19) United States
(12) Patent Application Publication
(10) Pub. No.: US 2026/0288711 A1
(43) Pub. Date: Sep. 24, 2026

(54) SCALABLE AND ACCURATE DATA QUERY GENERATION FROM NATURAL LANGUAGE QUERIES FOR QUERYING DATA SOURCES

(71) Applicant: SAP SE, Walldorf (DE)

(72) Inventor: Yi Quan Zhou, Singapore (SG)

(21) Appl. No.: 19/086,234

(22) Filed: Mar. 21, 2025

(51) Int. Cl. G06F 16/2452; G06N 3/042

(52) U.S. Cl. CPC G06F 16/24522; G06N 3/042

(57) ABSTRACT

Methods, systems, and computer-readable storage media for using a set of agents that are based on large language models (LLMs) to generate data queries for configuring applications, where a first LLM-based agent that is used to provide application properties based on application data sources and a knowledge graph during a design-time, and a second LLM-based agent is used to provide data queries at least partially based on the application properties during a runtime, the data queries being executable to retrieve data from one or more data sources within a cloud computing environment.

### BACKGROUND

Entities, such as commercial enterprises, use software systems to conduct operations. Example software systems can include, without limitation, enterprise resource management (ERP) systems, customer relationship management (CRM) systems, human capital management (HCM) systems, and the like. Enterprises continuously seek to improve and gain efficiencies in their operations. To this end, enterprises integrate systems in the domain of so-called intelligent enterprise, which can employ artificial intelligence (AI) that can include, for example, machine learning (ML) models. For example, AI can be used for data analytics and/or automating tasks in support of enterprise operations. AI, however, presents technical hurdles and risks that need to be mitigated.

### SUMMARY

Implementations of the present disclosure are directed to generating data queries that are executable to configure applications. More particularly, implementations of the present disclosure are directed to using a set of agents that are based on large language models (LLMs) to generate data queries for configuring applications. As described in further detail herein, implementations of the present disclosure include a first LLM-based agent that is used to provide application properties based on application data sources and a knowledge graph during a design-time, and a second LLM-based agent that is used to provide data queries at least partially based on the application properties during a runtime. In some examples, the data queries are executable to query data sources responsive to user queries.

In some implementations, actions include, during a design-time: providing an application identifier (app_ID) lookup table using a set of application data sources, the app_ID lookup table recording for each application of a set of applications, an app_ID and a set of application entities, providing a set of select/filter files for each application, each set of select/filter files recording configuration values for select, filter, and navigation properties of a respective application, prompting, for each application, one or more LLM systems to provide a set of abstracted property configurations, and generating, for each application and using a respective set of abstracted property configurations, a calibration mapping that provides configuration values for respective application entities, and, during a runtime: receiving a query from a user, the query being provided in natural language, prompting the one or more LLM systems using the query to provide application information for an application, determining, based on the application information, a respective calibration mapping for the application, prompting the one or more LLM systems using the query and the respective calibration mapping to return a structured data query, and executing the structured data query to retrieve data from one or more data sources within a cloud computing environment. Other implementations of this aspect include corresponding systems, apparatus, and computer programs, configured to perform the actions of the methods, encoded on computer storage devices.

These and other implementations can each optionally include one or more of the following features: actions further include, during the design-time, retrieving, from a knowledge graph database, a parameter set for each application, each parameter set including parameter values associated with application entities of a respective application, the calibration mapping being generated further using the parameter set of the respective application; actions further include, during the design-time, providing an embedding database by generating embeddings for calibration mappings, each embedding including a vector representation of a respective calibration mapping and being stored in the embedding database indexed to the respective calibration mapping; determining, based on the application information, a respective calibration mapping for the application includes generating an application information embedding as a vector representation of the application information, comparing the application information embedding to embeddings of the embedding database to identify a matching embedding, and returning the respective calibration mapping that is indexed to the matching embedding; prompting the one or more LLM systems using the query to provide application information for an application includes generating an application information prompt using the user query and the app_ID lookup table, the one or more LLM systems being queried using the application information prompt; actions further include, during the design-time, generating a select/filter prompt using a parameter set returned from a knowledge graph database for the application to prompt the one or more LLM systems to provide the set of abstracted property configurations; and the set of application data sources includes an application library, an application manifest store, and an application source code repository.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIGS. 3A and 3B depict example processes that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to generating data queries that are executable to configure applications. More particularly, implementations of the present disclosure are directed to using a set of agents that are based on large language models (LLMs) to generate data queries for configuring applications. As described in further detail herein, implementations of the present disclosure include a first LLM-based agent that is used to provide application properties based on application data sources and a knowledge graph during a design-time, and a second LLM-based agent that is used to provide data queries at least partially based on the application properties during a runtime. In some examples, the data queries are executable to query data sources responsive to user queries.

Implementations can include actions of, during a design-time: providing an application identifier (app_ID) lookup table using a set of application data sources, the app_ID lookup table recording for each application of a set of applications, an app_ID and a set of application entities, providing a set of select/filter files for each application, each set of select/filter files recording configuration values for select, filter, and navigation properties of a respective application, prompting, for each application, one or more LLM systems to provide a set of abstracted property configurations, and generating, for each application and using a respective set of abstracted property configurations, a calibration mapping that provides configuration values for respective application entities, and, during a runtime: receiving a query from a user, the query being provided in natural language, prompting the one or more LLM systems using the query to provide application information for an application, determining, based on the application information, a respective calibration mapping for the application, prompting the one or more LLM systems using the query and the respective calibration mapping to return a structured data query, and executing the structured data query to retrieve data from one or more data sources within a cloud computing environment.

Implementations of the present disclosure are described in further detail herein with non-limiting reference to applications, data sources, and the like that are provided by SAP SE of Walldorf, Germany. It is contemplated, however, that implementations of the present disclosure can be realized using any appropriate applications, data sources, and the like.

To provide further context for implementations of the present disclosure, and as introduced above, artificial intelligence (AI) is increasingly being leveraged in applications that support enterprise operations. In the field of AI, so-called generative AI (GAI) has recently seen an explosion in popularity. GAI can be described as including foundation models that generate content based on training data. For example, foundation models can include LLMs, which are a form of GAI that can be used to generate text and perform other functions for a variety of use cases. The increasing power and popularity of GAI has seen enterprises seeking avenues to leverage GAI in improving enterprise operations. However, integrating GAI into enterprise systems is a non-trivial task. For example, GAI can present various technical challenges, disadvantages, and limitations that have to be managed, which did not exist in the pre-GAI world.

In further detail, enterprise systems are highly customized according to specific operational models of an enterprise, individual customers of the enterprise, and users. For example, significant efforts in terms of development are expended to deliver suitable applications for customers. Even with tools, such as low-code/no-code development tools, users are still required to be familiar with the tools and convert requirements into configurations in the tools to create applications accordingly.

In view of this, LLMs can be seen as providing a solution for gaining efficiencies in provisioning applications. For example, a user can input requirements of an application into a LLM-based virtual agent (also referred to as a LLM-based chatbot), which is expected to understand the requirements, as provided in natural language by the user, identify relevant data sources, and provide a configuration for the application, which meets the requirements. In this context, a scenario can include using the LLM to convert natural language into a structured format, such as a data query that conforms to a defined data schema. Here, a LLM can be used to convert a user query (e.g., input to a chatbot in natural language) to an Open Data Protocol (OData) query (a data query that is structured). OData can be described as a standard that defines a structure for querying resources through RESTful application programming interfaces (APIs). In an example use case, the LLM-based virtual agent generates prompts based on the user queries, prompts one or more LLMs using the prompts, and returns responses ((structured) data queries) generated by the LLM(s). However, LLMs are provisioned by third-party service providers and are trained on training data from a broad range of domains. In short, LLMs are not domain-specific and, as such, do not perform well when applied to particular domains.

Accordingly, use of LLMs in this context presents multiple technical challenges. An example challenge is ensuring that LLM understands the requirements according to specific definitions relevant to data source formats and terms. For example, it is a known issue that LLMs are prone to hallucinations, which can be described as generation of content that is made-up, irrelevant, and/or inconsistent with the input to the LLM. For example, LLMs are known to give incorrect abstractions and/or interpretations responsive to input to the LLM (prompts). Leveraging knowledge represented within a knowledge graph (KG) database can help mitigate hallucinations. However, as a foundation database, a KG database is built upon data items having static semantic relationships therebetween. Some information on applications is not suitable to be represented within a KG. Another example challenge is how to scale for hundred-to-thousands of out-of-box clear core enterprise applications. Without a KG database, the application information is scattered.

Further, in using a LLM to convert user queries into data queries, such as OData queries, conversion can include identifying an entity set referenced in the user query from underlying metadata and generating the OData query based on the entity set and metadata information. However, in generating OData queries, and even when provided with the metadata as context, LLMs frequently misidentify entity sets, particularly in relatively long metadata files, incorrectly assign properties to the entity sets, and struggle to convert natural language values to OData service values. This results in ineffective or unusable OData queries wasting time and technical resources.

These failures occur because LLMs face significant challenges with OData metadata. For example, the metadata can be long, complex, and lacks contextual information. Here, even when a LLM is provided with the metadata as context, the metadata is relatively long and includes metadata that is irrelevant to the user query, which degrades performance of LLMs in generating usable OData queries. As another example, the complicated and overlapping relationships within the metadata make it difficult for LLMs to accurately interpret the data structure. As still another example, the absence of contextual annotations in the metadata limits the ability of the LLMs to understand and process the data accurately.

In view of the above context, implementations of the present disclosure enable LLM-based applications to prompt one or more LLMs to generate accurate data queries (e.g., OData URLs) responsive to natural language queries provided by users. As described in further detail herein, implementations of the present disclosure combine application-specific information and comprehensive data protocol information (e.g., OData information) and leverage a KG database to overcome technical issues that traditionally arise in use of LLMs, such as those described above.

In further detail, during design-time (e.g., prior to prompting LLMs to generate data queries during production), a KG database is built using various data sources, such as OData APIs, CDS Views, API Hub, etc. to setup a database with built-in semantic relations among data items, such as business objects, entities, APIs, properties, value help (ValueHelp), and the like. Application information of a set of applications including app info, app API, app entities, and app select/filter/navigation properties are obtained from application data sources (e.g., application library, application manifest files, application source code). Data retrieved from the application data sources is processed to generate an application identifier lookup table and application select/filter lookup files. In some examples, the application identifier lookup stores application identifiers, each being associated with application entities, which facilitate API retrieval from a knowledge graph database. In some examples, an application entity can be described as a data entity that is used by an application. For example, a “manage sales order” application is built on applications entities that can include “C_SalesOrderWI_F1873Type,” which includes properties of “SalesOrder,” “SalesOffice,” “SalesGroup,” and the like. In some examples, the application select/filter lookup files record actual configurations of select, filter, and navigation properties, such as provided in application manifests (e.g., manifest.json files), model files (e.g., model.js files), and the like. During runtime, a user query is received in natural language and is processed to prompt a LLM for a data query, which can be executed, as described in further detail herein.

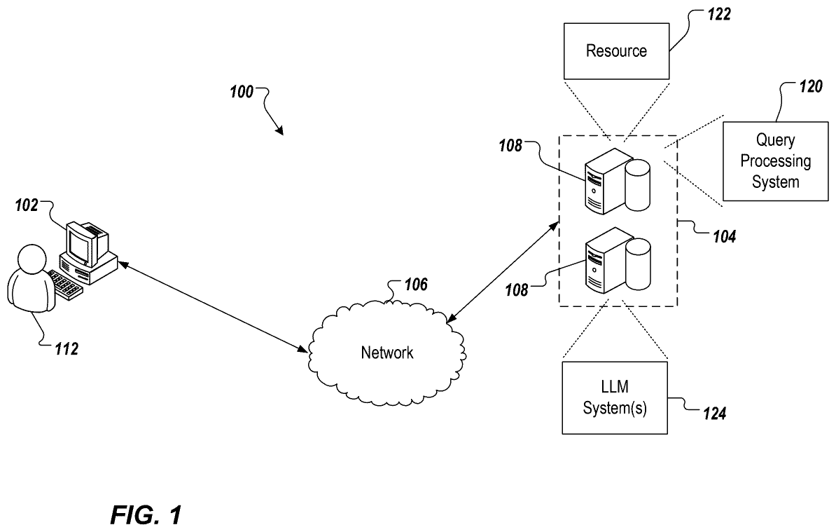

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a query processing system 120 for querying a resource 122 in response to a user query submitted by the user 112 through the client device 102. For example, the user 112 can interact with a chatbot on the client device 102 and can submit a user query to the query processing system 120 through the chatbot. As described in further detail herein, the query processing system 120 leverages a LLM provided by the LLM system 124. An example LLM can include, without limitation, gpt-3.5-turbo-16k provided by OpenAI. However, it is contemplated that any appropriate LLM can be used to realize implementations of the present disclosure.

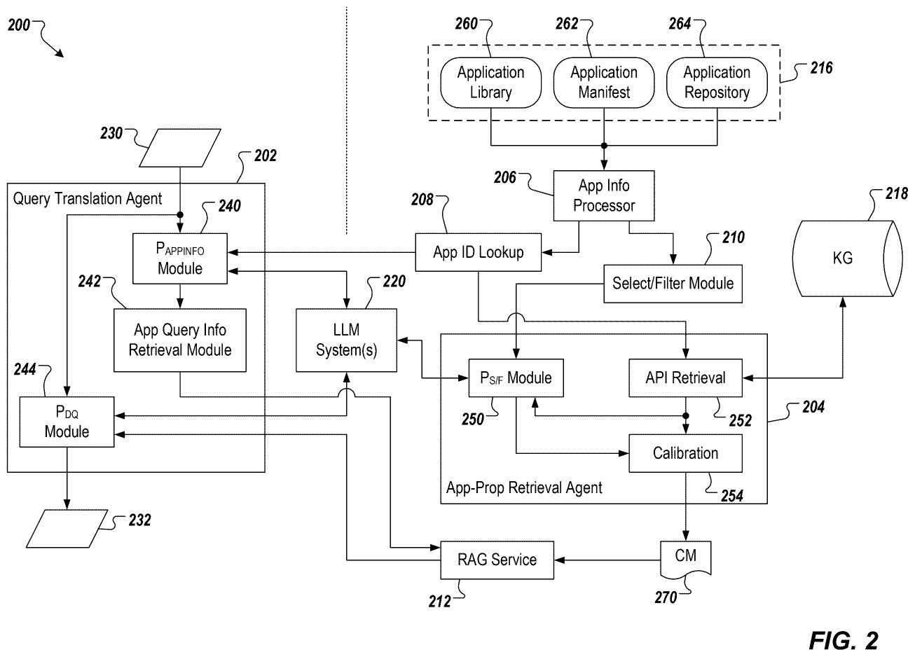

FIG. 2 depicts an example conceptual architecture 200 in accordance with implementations of the present disclosure. In the depicted example, the example conceptual architecture 200 includes a query translation agent 202, an application properties (app-prop) retrieval agent 204, an application information processor 206, an application identifier (app_ID) lookup module 208, a select/filter (S/F) module 210, a retrieval-augmented generation (RAG) service 212, application data sources 216, a KG database 218, and one or more LLM systems 220 (e.g., the one or more LLM systems 124 of FIG. 1). As described in further detail herein, during a runtime, the query translation agent 202 prompts the one or more LLM systems 220 to translate a query 230 (a natural language query input by a user) into a data query (e.g., OData URL) 232.

In further detail, in some examples, the query translation agent 202 includes an application information prompt (P_{APPINFO}) module 240, an application query information retrieval module 242, and a data query prompt (P_{DQ}) module 244. In some examples, the app-prop retrieval agent 204 includes a S/F prompt (P_{S/F}) module 250, an API retrieval module 252, and a calibration module 254. In some examples, the application data sources 216 includes an application library 260, an application manifest store 262, and an application repository 264.

In some implementations, during a design-time (prior to the query translation agent 202 receiving queries, such as the query 230), the KG database 218 is built based on data stored in various data sources. Example data used to construct the KG database 218 can include, without limitation, OData APIs, common data schema (CDS) views, API hubs, and the like. In some examples, the KG database 218 records built-in semantic relations between data items. Example data items can include, without limitation, business objects (e.g., data structures recording business data), entities, APIs, properties, and the like.

In general, a KG can be described as a graph dataset that represents networks of entities and characterizes relationships therebetween. Example entities include objects, events, situations, or concepts. A KG includes a set of nodes and a set of edges, where the nodes represent respective entities and edges between nodes define relationships between the nodes. More particularly, a KG can be described as a graph dataset made of directed, labeled edges that connect nodes representing concepts. In some instances, two nodes can be connected by multiple edges with distinct labels. As a result, KGs are multi-relational graphs. KGs can be defined using triples, each triple being a fact (also referred to as link) that can be defined as t=(s, p, o), where s is a subject, p is a predicate, and o is an object. In the context of the present disclosure, example triples can include [“purchase order”, “property”, “purchase group”], and [“purchase status”, “value”, “editing”].

In some implementations, during the design-time, source information for each application of a set of applications is obtained from the application data sources 216. Example application information can include, without limitation, application information, application API, application entities, and application S/F and navigation properties. Each application can be uniquely identified using a respective app_ID. For example, source information for applications can be indexed within each of the application data sources 216 by app_ID.

In some examples, the application library 260 stores application information that is descriptive of each application. For example, for each application, the application library 260 can store required back-end product (e.g., SAP S/4HANA), line of business (LoB) (e.g., Budget and Finance, Business Development, Customer, Operations, Sales, Sales and Marketing, Sales and Services, Service), application launcher title (e.g., Create Sales Orders, Manage Sales Orders), application type (e.g., transactional), database that the application queries (e.g., HANA DB), device types that the application can be executed on (e.g., desktop, tablet), descriptions of product features, implementation information (e.g., installation, configuration, extensibility), and related applications (e.g., Sales Volume—Check Open Sales, Display Credit Exposure). An example application library includes the Fiori Application Library provided by SAP SE.

In some examples, the application manifest store 262 stores an application manifest file for each of the applications. In general, an application manifest file can be described as a central descriptor for an application and can record configuration information (e.g., as metadata) needed to execute the application. Example configuration information can include, without limitation, version, title, supported devices, required components, data sources, and other configuration details. In some examples, manifest files are provided in Javascript Object Notation (JSON) format (e.g., manifest.json).

In further detail, and in the example context of SAP, the application manifest, also referred to as application descriptor, includes a set of namespaces, such as sap.app and sap.ui. In some examples, the sap.app namespace records a set of application-specific attributes, which can include app_ID (e.g., sap.fe.featureShowcase.mainApp), type (e.g., application), application version (e.g., 1.0.0), data sources, such as OData services with a unique key or alias, and specifying the URI, type and settings, such as the OData version (e.g., “uri”: “/srv1/”, “type”: “OData”, “settings”: {“odataVersion”: “4.0”}). In some examples, sap.ui namespace defines UI-specific attributes and content.

In some examples, the application repository 264 stores source code for each of the applications. For example, for each application, the application repository 264 can store a set of files that are executable to provision an instance of the application. An example file can include, without limitation, an annotation file (e.g., an annotation file in extensible markup language (XML) format) that records application property information.

In accordance with implementations of the present disclosure, for each application, the application information processor 206 retrieves application information from the application data sources 216 (e.g., based on app_ID) and processes the application information to generate an app_ID lookup table and S/F lookup files. In some examples, the app_ID lookup table records application parameters that can include, for example, app_ID, application name, application entities, business object, OData service, LoB, persona, and the like. In general, the application parameters represent parameters of applications that users could query for. In some examples, the application parameters facilitate downstream functionality, such as API retrieval from the KG database 218, as described herein. In some examples, the app_ID lookup table is provided to and maintained by the app_ID lookup module 208. In some examples, the S/F lookup files record configurations of select, filter, and navigation properties (e.g., manifest.json, model.js). In some examples, the S/F lookup files are provided to and maintained by the S/F module 210.

During the design-time, app-prop retrieval agent 204 interacts with the LLM systems 220 to, for each application, provide a calibration mapping and a properties configuration. In some examples, the P_{S/F} module 250 prompts the LLM systems 220, which returns a set of abstracted property configurations, responsive to the prompt.

In further detail, the API retrieval module 252 leverages the app_ID lookup table to determine a set of application entities for an application. For example, the app_ID of the application is used to index the app_ID lookup table, which provides the set of application entities. In some examples, the API retrieval module 252 queries the KG database 218 using the set of properties. In response to the query, the KG database 218 returns a parameter set for the application. In some examples, the parameter set includes properties, navigation, value help, and the like, associated with respective application entities. In some examples, the parameters in the parameter set are based on data object definitions on the application entities and are referenced by app_ID and application entity pairs as an index.

In some examples, the parameter set returned from the KG database 218 is provided to the P_{S/F} module 250 to generate the prompt that is used to prompt the LLM systems 220. For example, the P_{S/F} module 250 receives the S/F lookup files for the application and uses the S/F lookup files and parameter set to generate the prompt. In some examples, the S/F prompt is generated using a S/F prompt template. In some examples, the S/F prompt template includes static content and placeholders, where static content includes content (e.g., text) that is the same for every S/F prompt that is generated using the S/F prompt template, and placeholders can be populated with content (e.g., text, file names, URLs) that is specific to a particular S/F prompt. An example S/F prompt can be provided as:

Listing 1: Example S/F Prompt

context = f“““
Given the 3 file data as:
OData Schema: {“odata_schema_meta.xml”}
App Manifest: {“app_manifest.json”}
UI page source: {“ui_page_view.xml”}
”””
user_prompt = f“““
identify the “Select” properties in below steps:
1. start by examining all of properties in the section
‘<edmx:DataServices>’ of ‘odata_schema_meta.xml’, whose is set
as “yes” for attribute ‘Select’ in the section.
2. examining all of properties in the section
‘<edmx:DataServices>’ of ‘odata_schema_meta.xml’, whose is set
as “yes” for attribute ‘Filter’ in the section.
3. examining the section ‘SelectionFields’ of
‘app_manifest.json’, in which there is “FilterFields”. Extract
the properties and default values accordigly.
4. examining all of properties in the section
‘<edmx:DataServices>’ of ‘ui_page_view.xml’, whose is set as
“yes” for attribute ‘Select’ in the section.
5.
”””
prompt = [{“role”: “system”, “content”: context}, {“role”:
“user”, “content”: user_prompt}]
response = get_completion(prompt)

A portion of example data schema (OData schema) for SalesOrder can be provided as:

Listing 2: Example Data Schema

```
</EntityType>
<EntityType Name=“SalesOrderManageType”>
  <Key>
    <PropertyRef Name+“SalesOrder”/>
  </Key>
  <Property Name+“SalesOrder” Type=“Edm.String”
Nullable=“false” MaxLength=“10”/>
  <Property Name+“SalesOrderType” Type=“Edm.String”
Nullable=“false” MaxLength=“4”/>
  <Property Name+“SoldToParty” Type=“Edm.String”
Nullable=“false” MaxLength=“10”/>
  <Property Name+“CustomerName” Type=“Edm.String”
Nullable=“false” MaxLength=“80”/>
  <Property Name+“SoldToPartyAddressID” Type=“Edm.String”
Nullable=“false” MaxLength=“10”/>
  <Property Name+“SalesOrganization” Type=“Edm.String”
Nullable=“false” MaxLength=“4”/>
...
```

In some implementations, a LLM system 220 processes the S/F prompt and returns a response that includes a set of abstracted property configurations (e.g., abstracted select, filter, and navigation properties). In some examples, the set of abstracted property configurations are input to the calibration module 254, which also receives the parameter set that had been returned from the KG database 218. In some examples, the calibration module 254 generates a calibration mapping 270 between the indexing of app_ID and the application entities and the properties configuration by the application and the value help associated therewith. A non-limiting example of a calibration mapping is provided as:

Filter Candidate
PurchaseOrderStatus
Supplier
PurchaseOrder
DocumentCurrency
PurchasingGroup
PurchasingOrganization
PurchaseOrderDate
PurchaseOrderStatusName
CompanyCode
PurchaseOrderNetAmount
Value Help
PurchaseOrderStatus
Deleted: 10
Draft: 01
Follow-on Documents: 05
In Approval: 02
Not Yet Sent: 03
Output Error: 37
Rejected: 38
Sent: 04
. . .

### Example Calibration Mapping

In the above example, PurchaseOrderStatus is a filter property, for which configuration values come from a data set, and the configuration values indicate the respective status within the database (e.g., purchase orders with a status of 10 have been deleted, purchase orders with a status of 02 are in an approval process).

In some implementations, the calibration mapping 270 is processed by the RAG service 212, which generates an embedding for each record of the calibration mapping 270. For example, for each record of the calibration mapping 270, the RAG service 212 processes the record through an embedder (e.g., a pre-trained ML model) that outputs an embedding as a multi-dimensional vector that represents the record within an embedding space. For example, each record can represent a configuration parameter (e.g., to configure an application) and embeddings are multi-dimensional vector representations of respective records.

In accordance with implementations of the present disclosure, and as introduced above, during runtime, the query translation agent 202 prompts the one or more LLM systems 220 to translate a query 230 (a natural language query input by a user) into a data query (e.g., OData URL) 232. An example query can be provided as:
Show me the top 10 purchase orders.
   An example data query responsive to the above-example query can be provided as:

http://gct-715-api.devsys.net.sap:443/sap/opu/odata/sap/
MM_PUR_PO_MAINT_V2_SRV/C_PurchaseOrderTP?$top=10

In further detail, the P_{APPINFO} module 240 generates an APPINFO prompt based on the query 230 and the app_ID lookup table (e.g., provided from the app_ID lookup module 208). In some examples, the APPINFO prompt is generated using an APPINFO prompt template. In some examples, the APPINFO prompt template includes static content and placeholders, where static content includes content (e.g., text) that is the same for every APPINFO prompt that is generated using the APPINFO prompt template, and placeholders can be populated with content (e.g., text) that is specific to a particular APPINFO prompt. An example APPINFO prompt can be provided as:

Listing 3: Example APPINFO Prompt

context = f“““
Given the app_ID lookup table as below:
{“relevant_app_ID_table”}
”””
user_prompt = f“““
1. Examine the query (query) to identify the item which has
relevant business object and nature of Line of Business
2. Output the “app_ID” and “App Entity” in a json format.
”””
prompt = [{“role”: “system”, “content”: context}, {“role”:
“user”, “content”: user_prompt}]
response = get_completion(prompt)

In some examples, a LLM system 220 processes the APPINFO prompt and returns a response. In some examples, the response is provided in JSON format. An example response to the APPINFO prompt can be provide as:

| | |
|---|---|
| { | App Name: Manage Purchase Orders, |
| | App ID: F138, |
| | App Version: 2406 |
| } | |

In some examples, the response is used as input to call the RAG service 212, to fetch corresponding S/F parameters of the application, which are used in a data query prompt, as described herein.

In some implementations, the P_{DQ} module 244 generates a data query (DQ) prompt based on the query 230 and the S/F parameters (e.g., returned from the RAG service 212). In some examples, the DQ prompt is generated using a DQ prompt template. In some examples, the DQ prompt template includes static content and placeholders, where static content includes content (e.g., text) that is the same for every DQ prompt that is generated using the DQ prompt template, and placeholders can be populated with content (e.g., text) that is specific to a particular DQ prompt. An example DQ prompt can be provided as:

Listing 4: Example DQ Prompt

context = f“““
With the mapping data table: {table1}
”””
user_prompt = f“““
Do following tasks: \n
1. Examine the properties mentioned in query {query} from the
“Select” property set {select_property_set}.
2. Examine the properties mentioned in query {query} from the
“Filter” property set {select_property_set}.
3. Examine the possible value mentioned in query {query} from
the “Value Help” property set {valuehelp_property_set}.
4. output all examination outputs above in json format as {
Select: [ ], Filter: [ ], ValueHelp { {attribute}: [ ] }.
”””
prompt = [{“role”: “system”, “content”: context}, {“role”:
“user”, “content”: user_prompt}]
response = get_completion(prompt)

In accordance with implementations of the present disclosure, a LLM system 220 processes the DQ prompt and returns a data query in response. For example, the LLM system 220 returns an OData URL (e.g., see example above) that is responsive to the prompt.

In some implementations, the data query is executed to is used by a query processor to query a resource (e.g., a database system) for data responsive to the data query and return a query result. In some examples, for a static application, the data query (OData URL) is called to fetch the data and incorporate the data in UI display. In some examples, for a dynamic application, the data query (OData URL) is configured into a data request call to return data for processing by the application.

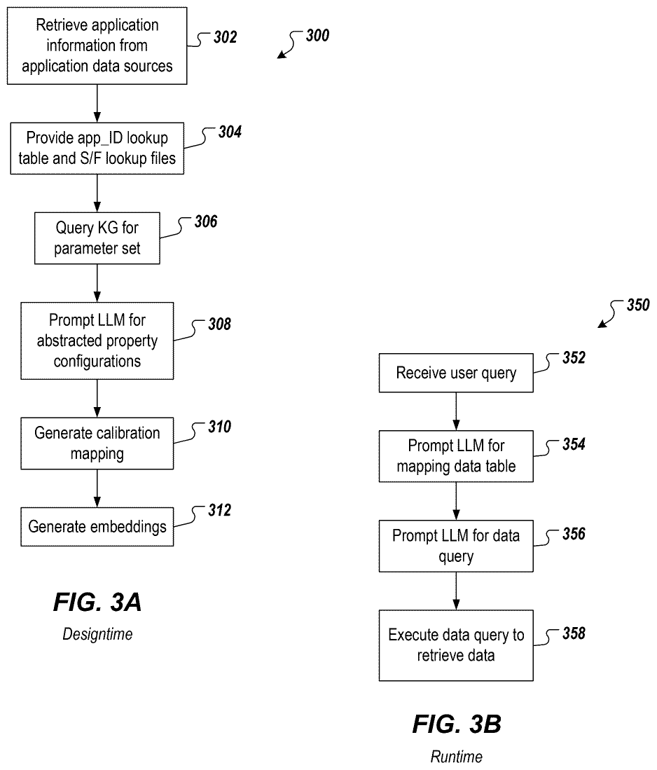

FIG. 3A depicts an example process 300 that can be executed in accordance with implementations of the present disclosure. In some examples, the example process 300 is provided using one or more computer-executable programs executed by one or more computing devices. In some examples, the example process 300 is executed during design-time. In some examples, the example process 300 is executed for each application ins a set of applications, each uniquely identifiable by app_ID.

Application information is retrieved (302) and an app_ID lookup table and S/F lookup files are provided (304). For example, and as described herein with reference to FIG. 2, the application information processor 206 retrieves application information from the application data sources 216 (e.g., based on app_ID) and processes the application information to generate an app_ID lookup table and S/F lookup files. The KG database is queried for a parameter set (306). For example, and as described herein, the API retrieval module 252 leverages the app_ID lookup table to determine a set of application entities for an application, where the app_ID of the application is used to index the app_ID lookup table, which provides the set of application entities. In some examples, the API retrieval module 252 queries the KG database 218 using the set of properties and the KG database 218 returns a parameter set for the application.

A LLM is prompted for abstract property configurations (308). For example, and as described herein, the parameter set returned from the KG database 218 is provided to the P_{S/F} module 250 to generate the S/F prompt that is used to prompt the LLM system 220. For example, the P_{S/F} module 250 receives the S/F lookup files for the application and uses the S/F lookup files and parameter set to generate the S/F prompt. The LLM system 220 processes the S/F prompt and returns a response that includes a set of abstracted property configurations (e.g., abstracted select, filter, and navigation properties).

A calibration mapping is generated (310). For example, and as described herein, the set of abstracted property configurations are input to the calibration module 254, which also receives the parameter set that had been returned from the KG database 218. In some examples, the calibration module 254 generates a calibration mapping 270 between the indexing of app_ID and the application entities and the properties configuration by the application and the value help associated therewith. Embeddings are generated (312). For example, and as described herein, the calibration mapping 270 is processed by the RAG service 212, which generates an embedding for each record of the calibration mapping 270. For example, for each record of the calibration mapping 270, the RAG service 212 processes the record through an embedder (e.g., a pre-trained ML model) that outputs an embedding as a multi-dimensional vector that represents the record within an embedding space.

FIG. 3B depicts an example process 350 that can be executed in accordance with implementations of the present disclosure. In some examples, the example process 350 is provided using one or more computer-executable programs executed by one or more computing devices. In some examples, the example process 300 is executed during a runtime.

A user query is received (352) and a LLM is prompted for a mapping data table (354). For example, and as described herein, with reference to FIG. 2, the P_{APPINFO} module 240 generates an APPINFO prompt based on the query 230 and the app_ID lookup table (e.g., provided from the app_ID lookup module 208), and the P_{DQ} module 244 generates a DQ prompt based on the query 230 and the response (e.g., returned from the RAG service 212). A LLM is prompted for a data query (356). For example, and as described herein, LLM system 220 processes the DQ prompt and returns a data query in response. For example, the LLM system 220 returns an OData URL that is responsive to the prompt. The data query is executed to retrieve data from one or more data sources (358). For example, and as described herein, the data query is used by a query processor to query a resource (e.g., a database system) for data responsive to the data query and return a query result. The query result can be displayed to the user and/or can be further processed by an application (e.g., for analytics).

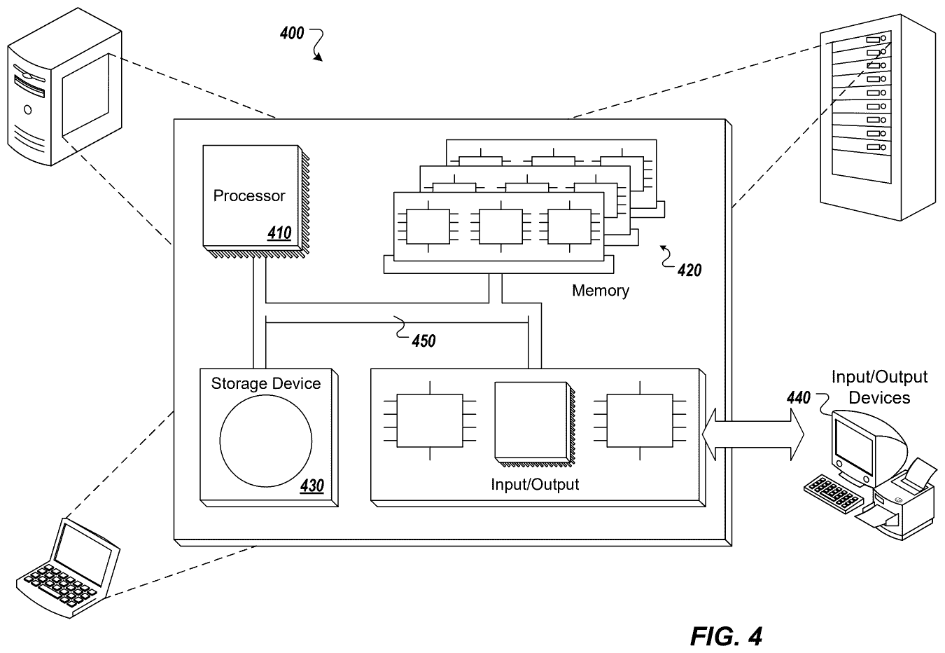

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

1. A computer-implemented method for configuring computer-executable applications using large language models (LLMs), the method being executed by one or more processors and comprising:
during a design-time:
providing an application identifier (app_ID) lookup table using a set of application data sources, the app_ID lookup table recording for each application of a set of applications, an app_ID and a set of application entities that facilitate application programming (API) retrieval from a knowledge graph database,
providing a set of select/filter files for each application, each set of select/filter files recording configuration values for select, filter, and navigation properties of a respective application,
prompting, for each application, one or more LLM systems to provide a set of abstracted property configurations, and
generating, for each application and using a respective set of abstracted property configurations, a calibration mapping that provides configuration values for respective application entities; and
during a runtime:
receiving a query from a user, the query being provided in natural language,
prompting the one or more LLM systems using the query to provide application information for an application,
determining, based on the application information, a respective calibration mapping for the application,
prompting the one or more LLM systems using the query and the respective calibration mapping to return a structured data query, and
executing the structured data query to retrieve data from one or more data sources within a cloud computing environment.

2. The method of claim 1, further comprising, during the design-time, retrieving, from the knowledge graph database, a parameter set for each application, each parameter set comprising parameter values associated with application entities of a respective application, the calibration mapping being generated further using the parameter set of the respective application.

3. The method of claim 1, further comprising, during the design-time, providing an embedding database by generating embeddings for calibration mappings, each embedding comprising a vector representation of a respective calibration mapping and being stored in the embedding database indexed to the respective calibration mapping.

4. The method of claim 3, wherein determining, based on the application information, a respective calibration mapping for the application comprises:
generating an application information embedding as a vector representation of the application information,
comparing the application information embedding to embeddings of the embedding database to identify a matching embedding, and
returning the respective calibration mapping that is indexed to the matching embedding.

5. The method of claim 1, wherein prompting the one or more LLM systems using the query to provide application information for an application comprises generating an application information prompt using the user query and the app_ID lookup table, the one or more LLM systems being queried using the application information prompt.

6. The method of claim 1, further comprising, during the design-time, generating a select/filter prompt using a parameter set returned from the knowledge graph database for the application to prompt the one or more LLM systems to provide the set of abstracted property configurations.

7. The method of claim 1, wherein the set of application data sources comprises an application library, an application manifest store, and an application source code repository.

8. A non-transitory computer-readable storage medium coupled to one or more processors and having instructions stored thereon which, when executed by the one or more processors, cause the one or more processors to perform operations for developing applications leveraging machine learning (ML) models, the operations comprising:
during a design-time:
providing an application identifier (app_ID) lookup table using a set of application data sources, the app_ID lookup table recording for each application of a set of applications, an app_ID and a set of application entities that facilitate application programming (API) retrieval from a knowledge graph database, providing a set of select/filter files for each application, each set of select/filter files recording configuration values for select, filter, and navigation properties of a respective application,
prompting, for each application, one or more LLM systems to provide a set of abstracted property configurations, and
generating, for each application and using a respective set of abstracted property configurations, a calibration mapping that provides configuration values for respective application entities; and
during a runtime:
receiving a query from a user, the query being provided in natural language,
prompting the one or more LLM systems using the query to provide application information for an application,
determining, based on the application information, a respective calibration mapping for the application,
prompting the one or more LLM systems using the query and the respective calibration mapping to return a structured data query, and
executing the structured data query to retrieve data from one or more data sources within a cloud computing environment.

9. The non-transitory computer-readable storage medium of claim 8, wherein operations further comprise, during the design-time, retrieving, from the knowledge graph database, a parameter set for each application, each parameter set comprising parameter values associated with application entities of a respective application, the calibration mapping being generated further using the parameter set of the respective application.

10. The non-transitory computer-readable storage medium of claim 8, wherein operations further comprise, during the design-time, providing an embedding database by generating embeddings for calibration mappings, each embedding comprising a vector representation of a respective calibration mapping and being stored in the embedding database indexed to the respective calibration mapping.

11. The non-transitory computer-readable storage medium of claim 10, wherein determining, based on the application information, a respective calibration mapping for the application comprises:
generating an application information embedding as a vector representation of the application information,
comparing the application information embedding to embeddings of the embedding database to identify a matching embedding, and
returning the respective calibration mapping that is indexed to the matching embedding.

12. The non-transitory computer-readable storage medium of claim 8, wherein prompting the one or more LLM systems using the query to provide application information for an application comprises generating an application information prompt using the user query and the app_ID lookup table, the one or more LLM systems being queried using the application information prompt.

13. The non-transitory computer-readable storage medium of claim 8, wherein operations further comprise, during the design-time, generating a select/filter prompt using a parameter set returned from the knowledge graph database for the application to prompt the one or more LLM systems to provide the set of abstracted property configurations.

14. The non-transitory computer-readable storage medium of claim 8, wherein the set of application data sources comprises an application library, an application manifest store, and an application source code repository.

15. A system, comprising:
a computing device; and
a computer-readable storage device coupled to the computing device and having instructions stored thereon which, when executed by the computing device, cause the computing device to perform operations for developing applications leveraging machine learning (ML) models, the operations comprising:
during a design-time:
providing an application identifier (app_ID) lookup table using a set of application data sources, the app_ID lookup table recording for each application of a set of applications, an app_ID and a set of application entities that facilitate application programming (API) retrieval from a knowledge graph database,
providing a set of select/filter files for each application, each set of select/filter files recording configuration values for select, filter, and navigation properties of a respective application,
prompting, for each application, one or more LLM systems to provide a set of abstracted property configurations, and
generating, for each application and using a respective set of abstracted property configurations, a calibration mapping that provides configuration values for respective application entities; and
during a runtime:
receiving a query from a user, the query being provided in natural language,
prompting the one or more LLM systems using the query to provide application information for an application,
determining, based on the application information, a respective calibration mapping for the application,
prompting the one or more LLM systems using the query and the respective calibration mapping to return a structured data query, and
executing the structured data query to retrieve data from one or more data sources within a cloud computing environment.

16. The system of claim 15, wherein operations further comprise, during the design-time, retrieving, from the knowledge graph database, a parameter set for each application, each parameter set comprising parameter values associated with application entities of a respective application, the calibration mapping being generated further using the parameter set of the respective application.

17. The system of claim 15, wherein operations further comprise, during the design-time, providing an embedding database by generating embeddings for calibration mappings, each embedding comprising a vector representation of a respective calibration mapping and being stored in the embedding database indexed to the respective calibration mapping.

18. The system of claim 17, wherein determining, based on the application information, a respective calibration mapping for the application comprises:
generating an application information embedding as a vector representation of the application information,
comparing the application information embedding to embeddings of the embedding database to identify a matching embedding, and
returning the respective calibration mapping that is indexed to the matching embedding.

19. The system of claim 15, wherein prompting the one or more LLM systems using the query to provide application information for an application comprises generating an application information prompt using the user query and the app_ID lookup table, the one or more LLM systems being queried using the application information prompt.

20. The system of claim 15, wherein operations further comprise, during the design-time, generating a select/filter prompt using a parameter set returned from the knowledge graph database for the application to prompt the one or more LLM systems to provide the set of abstracted property configurations.
